(19) United States
(12) Patent Application Publication
(10) Pub. No.: US 2021/0378430 A1
(43) Pub. Date: Dec. 9, 2021

(54) Method and apparatus to create a decorative drinking straw that is thermally insulated

(71) Applicants: Jerrold Scott Pine, Boca Raton, FL (US); Brandon T. Michaels, Palm Beach Gardens, FL (US); Kyriakos Antonis Tomadakis, Boca Raton, FL (US)

(72) Inventors: Jerrold Scott Pine, Boca Raton, FL (US); Brandon T. Michaels, Palm Beach Gardens, FL (US); Kyriakos Antonis Tomadakis, Boca Raton, FL (US)

(21) Appl. No.: 17/340,330

(22) Filed: Jun. 7, 2021

Related U.S. Application Data
(60) Provisional application No. 63/036,368, filed on Jun. 8, 2020.

(51) Int. Cl. A47G 21/18; B29D 23/00

(52) U.S. Cl. CPC A47G 21/182; B29K 2069/00; B29C 2795/002; B29D 23/00

(57) ABSTRACT

This present invention pertains to a method and apparatus to create a decorative drinking straw that is thermally insulated. Its tube in tube construction protects the decorative content from leaching pigment and chemicals into a beverage. The tube in tube construction also prevents fading, peeling, scratching, and abrasive damage to the decorative content.

This application claims the benefit of U.S. Provisional Application No. 63/036,368, filed Jun. 8, 2020.

### TECHNICAL FIELD

The present invention relates to a decorative straw, more particularly, the present invention pertains to a method and apparatus to create a decorative drinking straw that is thermally insulated. Its tube in tube construction protects the decorative content.

### BACKGROUND OF THE INVENTION

Disposable plastic drinking straws are contributing significantly to global pollution and wasteful landfills. It is not a secret that plastics draw on dwindling fossil fuels, leach harmful chemicals, litter landscapes, and destroy marine life. Environmental groups have targeted disposable drinking straws that are not recyclable or compostable for extinction. The ultimate goal: Prevent non-degradable plastic straws from polluting our parks, beaches, waterways and oceans. The plastics industry acknowledges that waste management and marine debris are serious issues that require a real and lasting solution.

One solution is to ban drinking straws, but a better solution is to create a reusable, decorative straw that is durable and can be easily cleaned, disinfected, and handled thousands of times. There are reusable straws on the market however they tend to have decorative elements that are fragile or decorative markings that can leach chemicals into beverages. Decorative markings are also subject to fading, peeling, and abrasion from everyday handling and cleaning methodologies like automated dishwashing.

Another nice feature for a reusable straw is useful when consuming hot beverages. The best thermos on the market is constructed as a glass bottle within another glass bottle separated by an air gap which provides great thermal insulation. With this construction adapted to drinking straws, hot beverages that can reach 200 degrees Fahrenheit would flow through a glass inner tube, separated by an air gap to an outer glass tube which is thermally insulated and stays cool when touched by hand or in contact with your lips. With a tube inside a tube construction, the decorative elements can be on the outer surface of the inner tube or contained within the gap between tubes and hermetically sealed between the inner and outer tubes overcoming the limitations of exterior decorative elements on existing drinking straws.

It is the intent of this invention to illustrate a method and apparatus to construct a reusable drinking straw that protects decorative elements on it and thermally insulates hot beverages through it from the outer straw surfaces.

### SUMMARY OF THE INVENTION

What is needed is a reusable drinking straw with a transparent, heat resistant inner tube encased within a transparent, heat resistant outer tube with the inner and outer tubes concentric, separated by an air gap, and hermetically sealed at each end.

What is further needed are decorative elements on the outer surface of the inner tube for creating a pleasing aesthetic for the reusable drinking straw.

What is further needed are decorative elements captured within the gap between inner tube and outer tube for creating a pleasing aesthetic for the reusable drinking straw.

What is further needed is for the transparent, heat resistant inner tube encased within a transparent, heat resistant outer tube to be chemically inert to all drinking beverages and chemically inert to the environments where used, cleaned, and disinfected.

What is further needed is for the reusable drinking straw to be durable if dropped and resistant to scratching, abrasion, and fading.

What is further needed is for the decorative drinking straw to have decorative content in the form of logos for advertising and promotional value.

### BRIEF DESCRIPTION OF THE DRAWINGS

The present invention will become more fully understood from the detailed description given hereinbelow and the accompanying drawings which are given by way of illustration only, and thus are not limitive of the present invention, and wherein:

FIG. 1 is a perspective view of a transparent, heat resistant outer tube, while in use, according to the present invention.

FIG. 2 is a perspective view of a transparent, heat resistant inner tube, while in use, according to the present invention.

FIG. 3 is a front view of decorative content, while in use, according to the present invention.

FIG. 4 is a perspective view of the transparent, heat resistant inner tube with decorative content, while in use, according to the present invention.

FIG. 5 is a perspective view of the transparent, heat resistant inner tube with decorative content encased and concentric within a transparent, heat resistant outer tube, while in use, according to the present invention.

FIG. 6 is a partial perspective view of one end of the transparent, heat resistant inner tube with decorative content encased within a transparent, heat resistant outer tube that illustrates the gap between inner and outer tube, while in use, according to the present invention.

FIG. 7 is a partial perspective view of one end of the transparent, heat resistant inner tube with decorative content encased within a transparent, heat resistant outer tube that illustrates the hermetic seal between the inner and outer tube, while in use, according to the present invention.

### DETAILED DESCRIPTION OF THE PREFERRED EMBODIMENTS

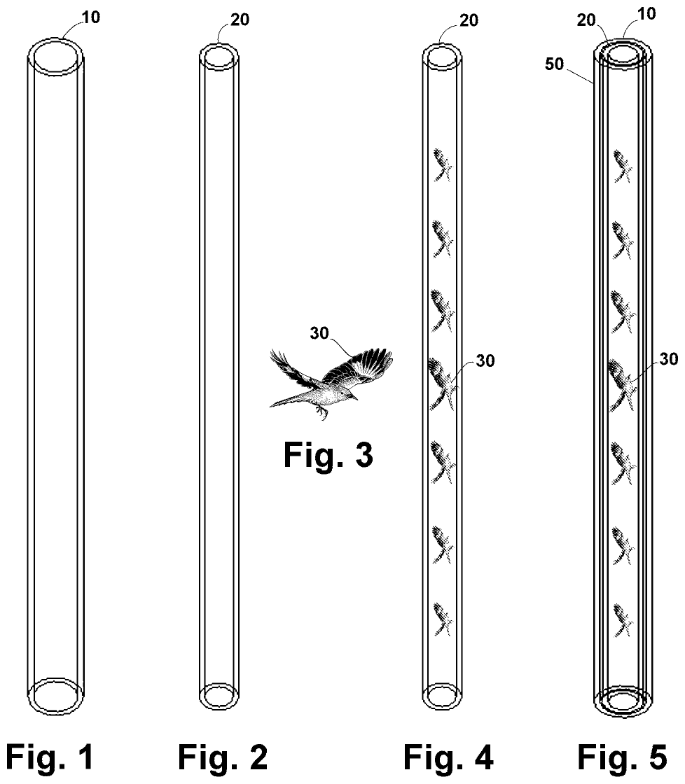

Referring to FIGS. 1 and 2 are perspective views of transparent, heat resistant outer tube 10 and transparent, heat resistant inner tube 20. The outer tube 10 and inner tube 20 in the present invention are made of borosilicate glass, but could be made from many formulations of glass or other high temperature transparent materials such as acrylic and polycarbonates formulated for immunity to high temperatures below 250 degrees Fahrenheit and are chemically inert across all beverages and cleaning solutions. Both the outer tube 10 and inner tube 20 are the same length typically between 6 and 10 inches long but may be any length appropriate for a decorative drinking straw 50. Outer tube 10 in the present invention has an outside diameter of approximately 0.500 inches and an inside diameter of approximately 0.400 inches which yields a wall thickness that is 0.050 inches thick. Inner tube 20 in the present invention has an outside diameter of approximately 0.360 inches and an inside diameter of approximately 0.260 inches which yields a wall thickness that is 0.050 inches thick. Diameters of both tubes can be any size appropriate for a drinking straw as long as they are capable of nesting within each other. Both inner tube 20 and outer tube 10 may also be tinted with a color that is translucent.

Referring to FIG. 3 is a front view of decorative content 30 such as the illustration of a bird pictured here. Decorative content 30 will generally be some type of artwork in the form of paint, stain, glow in the dark pigment, or inks that are generally painted, ink jet printed, tampo pad printed or deposited in any manner on to a surface. The decorative content 30 may be created directly on a surface or on a label or decal that is heat resistant and placed on a surface. The decorative content 30 can be two dimensional or 3 dimensional or could be etched into a surface. The artwork of decorative content 30 can be any color or combinations of colors to produce an aesthetically pleasing design. The decorative content 30 could be company logo, sports team logo, restaurant logo or any other type of logo or design for purposes of advertisements or promotional value. The decorative content 30 could be a static design or dynamic design that changes with viewing angle or physical angle of the surface with various techniques known in the art.

Referring to FIG. 4, the transparent, heat resistant inner tube 20 has decorative content 30 along most of the length of the outer surface. The decorative content 30 can be incorporated on some or on the entire outer surface of inner tube 20.

Referring to FIG. 5, transparent, heat resistant inner tube 20 with decorative content 30 is concentric with and encased within the transparent, heat resistant outer tube 10 with both ends aligned. The decorative content 30 is sandwiched between the inner tube 20 and outer tube 10 protecting it from to fading, peeling, scratching, and abrasion.

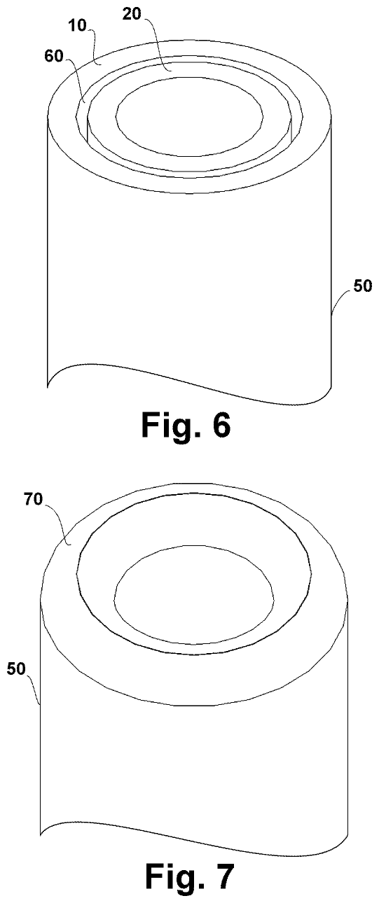

Referring to FIG. 6, is a close-up of one end of the transparent, heat resistant inner tube 20 with decorative content 30 that is concentric with and encased within the transparent, heat resistant outer tube 10. FIG. 6 illustrates how the tubes are concentric which creates an air gap 60 between the tubes. The air gap 60 has a low thermal conductivity of approximately 0.0026 Wm/K which prevents the transfer of heat from the inner tube 20 to the outer tube 10. Hot fluids traveling through inner tube 20 do not transfer heat to outer tube 10 that maintains a cool outer surface on the decorative drinking straw 50 for your lips and touch.

Referring to FIG. 7, is a close-up of one end of the transparent, heat resistant inner tube 20 with decorative content 30 that is concentric with and encased within the transparent, heat resistant outer tube 10. FIG. 7 illustrates how the tube ends are fused together. In this embodiment the fused end 70 is created by heating the end of the tubes with a torch and melting the tubes together. A short spacer may be placed at each end to keep the tubes concentric. The spacer may be fused with the ends to help complete the hermetic seal. It can be appreciated that the means to fuse the ends of the tubes together depend on the material used in the tubes and therefore the fusing means could be a heating means, chemical means or inert adhesive. The fused end 70 on both sides of the decorative drinking straw 50 hermetically seals the gaps between tubes. The hermetic seal further protects the decorative content 30 from leaching into any beverage and prevents pigments from the decorative content 30 from fading and washing away. If the air gap 60 between tubes is filled with a thermally insulating fluid filled with particulate, it could appear like a snow globe when the decorative drinking straw 50 is shaken. The finished decorative drinking straw 50 could further be heat treated and shaped with bends so the final straw shape is no longer a simple straight straw. If the air gap 60 between tubes is filled with a fluid such as water or an alcohol solution the decorative drinking straw 50 could be placed in the freezer prior to use and could help cool the beverage as it is consumed.

It will thus be seen that the needs set forth above, and those made apparent from the preceding descriptions, are effectively attained and since certain changes may be made in the above construction without departing from the spirit and scope of the invention, it is intended that all matter contained in the above description or shown in the accompanying drawings, shall be interpreted as illustrative and not in a limiting sense.

It is also to be understood that the following claims are intended to cover all generic and specific features of the invention herein described and all statements of scope of the invention, which as a matter of language, might be said to fall there between.

What is claimed is:

1. A reusable drinking straw comprising:
an inner tube encased within a larger diameter transparent, outer tube;
said inner tube and said outer tube substantially equal in overall length having both ends aligned;
said inner tube concentric to said outer tube;
said inner tube and said outer tube separated by an air gap which is hermetically sealed at each end; and
decorative elements on the outer surface of the inner tube creating a pleasing aesthetic for said reusable drinking straw.

2. The inner tube and outer tube according to claim 1 wherein said inner tube and said outer tube are heat resistant to temperatures below 250 degrees Fahrenheit.

3. The reusable drinking straw according to claim 1 wherein decorative elements are captured within the gap between said inner tube and said outer tube for creating a pleasing aesthetic for said reusable drinking straw.

4. The reusable drinking straw according to claim 1 wherein heat resistant inner tube encased within a transparent, heat resistant outer tube is chemically inert to all drinking beverages and chemically inert to the environments where used, cleaned, and disinfected.

5. The reusable drinking straw according to claim 1 wherein said reusable drinking straw is comprised of materials to be drop resistant and resistant to scratching, abrasion, and fading.

6. The decorative elements according to claim 1 wherein said decorative content is in the form of logos for advertising and promotional value.

7. The inner tube and outer tube according to claim 1 wherein said inner tube and said outer tube are made of borosilicate glass, or other formulations of high temperature glass or other high temperature transparent plastic materials including acrylic and polycarbonates.

8. The inner tube and outer tube according to claim 1 wherein said inner tube and said outer tube are both transparent materials.

9. The inner tube and outer tube according to claim 1 wherein said inner tube and said outer tube will be tinted with a translucent color.

10. The inner tube and outer tube according to claim 1 wherein said inner tube and said outer tube are 6-10 inches long.

11. The decorative elements according to claim 1 wherein said decorative content will be some type of artwork in the form of paint, stain, glow in the dark pigment, or inks that are generally painted, ink jet printed, tampo pad printed or deposited in any manner on to a surface.

12. The decorative elements according to claim 1 wherein said decorative content will be created directly on a surface or on a label or decal that is heat resistant and placed on a surface.

13. The air gap according to claim 1 wherein said air gap is filled with a liquid containing solid particulate that moves freely within the gap.

14. The air gap according to claim 1 wherein said air gap is thermally insulating to reduce heat transfer from said inner tube with hot liquid flowing through it to said outer tube.

15. The outer tube according to claim 1 wherein said outer tube contains decorative artwork.

16. The inner tube and outer tube according to claim 1 wherein said inner tube and said outer tube ends are fused together with a heating process, chemical process, or adhesive process.

17. The reusable drinking straw according to claim 1 wherein said reusable drinking straw is heat treated to form a curved non-linear shape.

18. A method to produce a reusable drinking straw comprising:
Decorating the outer surface of an inner tube;
Placing said inner tube concentrically within a larger diameter outer tube of substantially equal length having both ends aligned with tubes separated by an air gap; and
hermetically fusing and sealing each end.

19. A method to produce a reusable drinking straw means according to claim 18 where the said hermetic seal to fuse the ends of the tubes together is dependent on the tube material and therefore the fusing means will require a heating means, chemical means or inert adhesive means.

20. A method to produce a reusable drinking straw means according to claim 18 where said air gap is filled with a liquid containing solid particulate.

21. A method to produce a reusable drinking straw means according to claim 18 where said air gap contains one or more decorative means.

22. A method to produce a reusable drinking straw means according to claim 18 where a spacer is placed in said air gap to maintain concentricity and is fused with said ends to help hermetically seal the assembly.
